(19) United States
(12) Patent Application Publication
(10) Pub. No.: US 2024/0356703 A1
(43) Pub. Date: Oct. 24, 2024

(54) REFERENCE SIGNAL PORT INDICATION METHOD, TERMINAL, AND NETWORK SIDE DEVICE

(71) Applicant: VIVO MOBILE COMMUNICATION CO., LTD., Dongguan (CN)

(72) Inventors: Rongrong SUN, Dongguan (CN); Peng SUN, Dongguan (CN); Rakesh TAMRAKAR, Dongguan (CN)

(73) Assignee: VIVO MOBILE COMMUNICATION CO., LTD., Dongguan (CN)

(21) Appl. No.: 18/754,144

(22) Filed: Jun. 25, 2024

Related U.S. Application Data
(63) Continuation of application No. PCT/CN2022/141964, filed on Dec. 26, 2022.

(30) Foreign Application Priority Data
Dec. 28, 2021 (CN) 202111627138.0

(51) Int. Cl. H04L 5/00

(52) U.S. Cl. CPC H04L 5/0051

(57) ABSTRACT

This application discloses a reference signal port indication method, a terminal, and a network side device. The reference signal port indication method includes: receiving, by a terminal, target signaling, where the target signaling includes an antenna port indicator field, and the antenna port indicator field is used to indicate a demodulation reference signal (DMRS) port of an uplink channel; and determining, by the terminal, at least two DMRS port groups based on the antenna port indicator field, or determining an uplink transmission mode of the terminal based on the antenna port indicator field.

### CROSS-REFERENCE TO RELATED APPLICATIONS

This application is a continuation of International Application No. PCT/CN2022/141964, filed Dec. 26, 2022, which claims priority to Chinese Patent Application No. 202111627138.0, filed Dec. 28, 2021. The entire contents of each of the above-referenced applications are expressly incorporated herein by reference.

### TECHNICAL FIELD

This application relates to the field of wireless communication technologies, and in particular, to a reference signal port indication method, a terminal, and a network side device.

### BACKGROUND

A network side device may indicate, to a terminal by using Downlink Control Information (DCI), a Demodulation Reference Signal (DMRS) port that is used to send a Physical Uplink Shared Channel (PUSCH). In a related technology, the network side device indicates only one group of DMRS ports in the DCI, and different DMRS ports in the group of DMRS ports may occupy a same time-frequency resource. In a Multi Transmission Reception Point (MTRP) scenario, when a PUSCH is sent to different Transmission Reception Point (TRP) by using different transport layers, if different DMRS ports that occupy a same time-frequency resource are used, mutual interference is caused, demodulation of the PUSCH is affected, and transmission performance of uplink data is reduced.

### SUMMARY

Embodiments of this application provide a reference signal port indication method, a terminal, and a network side device.

According to a first aspect, a reference signal port indication method is provided, including:
receiving, by a terminal, target signaling, where the target signaling includes an antenna port indicator field, and the antenna port indicator field is used to indicate a DMRS port of an uplink channel; and
determining, by the terminal, at least two DMRS port groups based on the antenna port indicator field, or determining an uplink transmission mode of the terminal based on the antenna port indicator field.

According to a second aspect, a reference signal port indication method is provided, including:
sending, by a network side device, target signaling, where the target signaling includes an antenna port indicator field, and the antenna port indicator field is used to indicate a DMRS port of an uplink channel, so that a terminal determines at least two DMRS port groups based on the antenna port indicator field, or determines an uplink transmission mode of the terminal based on the antenna port indicator field.

According to a third aspect, a reference signal port indication apparatus is provided, including:
a receiving module, configured to receive target signaling, where the target signaling includes an antenna port indicator field, and the antenna port indicator field is used to indicate a DMRS port of an uplink channel; and
a determining module, configured to determine at least two DMRS port groups based on the antenna port indicator field, or determine an uplink transmission mode of a terminal based on the antenna port indicator field.

According to a fourth aspect, a reference signal port indication apparatus is provided, including:
a sending module, configured to send target signaling, where the target signaling includes an antenna port indicator field, and the antenna port indicator field is used to indicate a DMRS port of an uplink channel, so that a terminal determines at least two DMRS port groups based on the antenna port indicator field, or determines an uplink transmission mode of the terminal based on the antenna port indicator field.

According to a fifth aspect, a terminal is provided. The terminal includes a processor and a memory, the memory stores a program or an instruction that can be run on the processor, and the program or the instruction is executed by the processor to implement the steps of the method according to the first aspect.

According to a sixth aspect, a terminal is provided, including a processor and a communication interface. The communication interface is configured to receive target signaling, where the target signaling includes an antenna port indicator field, and the antenna port indicator field is used to indicate a DMRS port of an uplink channel. The processor is configured to determine at least two DMRS port groups based on the antenna port indicator field, or determine an uplink transmission mode of the terminal based on the antenna port indicator field.

According to a seventh aspect, a network side device is provided. The network side device includes a processor and a memory, and the memory stores a program or an instruction that can run on the processor, and when the program or the instruction is executed by the processor, steps of the method according to the second aspect are implemented.

According to an eighth aspect, a network side device is provided, including a processor and a communications interface. The communication interface is configured to send target signaling, where the target signaling includes an antenna port indicator field, and the antenna port indicator field is used to indicate an DMRS port of an uplink channel, so that a terminal determines at least two DMRS port groups based on the antenna port indicator field, or determines an uplink transmission mode of the terminal based on the antenna port indicator field.

According to a ninth aspect, a reference signal port indication system is provided, including a terminal and a network side device. The terminal may be configured to perform steps of the reference signal port indication method according to the first aspect, and the network side device may be configured to perform steps of the reference signal port indication method according to the second aspect.

According to a tenth aspect, a readable storage medium is provided. The readable storage medium stores a program or an instruction, and when the program or the instruction is executed by a processor, steps of the method according to the first aspect or steps of the method according to the second aspect are implemented.

According to an eleventh aspect, a chip is provided. The chip includes a processor and a communication interface, the communication interface is coupled to the processor, and the processor is configured to run a program or an instruction to implement the method according to the first aspect or the method according to the second aspect.

According to a twelfth aspect, a computer program product is provided. The computer program product is stored in a storage medium, and the computer program product is executed by at least one processor to implement steps of the method according to the first aspect or the second aspect.

In the embodiments of this application, the terminal can determine at least two DMRS port groups or determine an uplink transmission mode of the terminal based on a DMRS port used for an uplink channel and indicated by an antenna port indicator field. Because at least two DMRS port groups are determined, PUSCHs sent by using different beams in an MTRP scenario may correspondingly use DMRS ports in different DMRS port groups. When different time-frequency resources are used for DMRS ports in different DMRS port groups, mutual interference can be reduced, and transmission performance of uplink data is improved.

### BRIEF DESCRIPTION OF DRAWINGS

FIG. 1 is a block diagram of a wireless communication system to which embodiments of this application are applicable;

FIG. 2 is a schematic diagram of an MTRP PUSCH transmission scenario;

FIG. 3 is a schematic diagram of a structure of a TPMI or SRI indicator field;

FIG. 4A and FIG. 4B are schematic diagrams of DMRS CDM groups;

FIG. 5 is a schematic flowchart of a reference signal port indication method according to an embodiment of this application;

FIG. 6 is a schematic flowchart of a reference signal port indication method according to another embodiment of this application;

FIG. 7 is a schematic diagram of a structure of a reference signal port indication apparatus according to an embodiment of this application;

FIG. 8 is a schematic diagram of a structure of a reference signal port indication apparatus according to an embodiment of this application;

FIG. 9 is a schematic diagram of a structure of a communication device according to an embodiment of this application;

FIG. 10 is a schematic diagram of a hardware structure of a terminal according to an embodiment of this application; and

FIG. 11 is a schematic diagram of a hardware structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

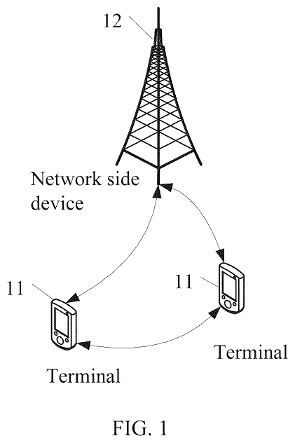

FIG. 1 is a block diagram of a wireless communication system to which embodiments of this application are applicable. The wireless communication system includes a terminal 11 and a network side device 12. The terminal 11 may be a terminal side device such as a mobile phone, a tablet personal computer, a laptop computer that is referred to as a notebook computer, a personal digital assistant (PDA), a palm computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home device (a home device with a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, or a smart anklet chain, or the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a WiFi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another appropriate term in the art. Provided that the same technical effect is achieved, the base station is not limited to specific technical vocabulary. It should be noted that in the embodiments of this application, a base station in the NR system is merely used as an example, but a specific type of the base station is not limited.

First, the communication terms involved in this application are briefly explained below.

### (1) Multi Transmission Reception Point (MTRP) PUSCH Transmission Scenario

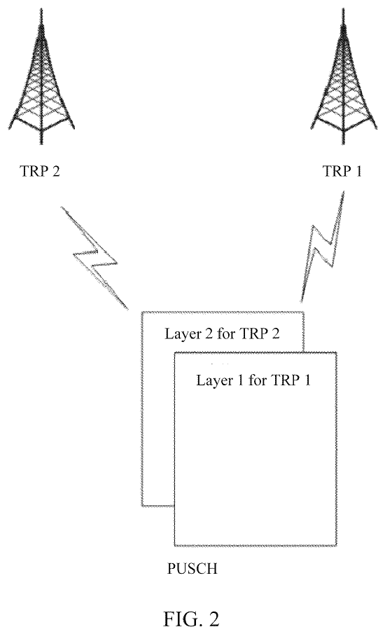

As shown in FIG. 2, when a terminal supports panel simultaneous sending, Space Division Multiplexing (SDM) enhancement may be introduced into an MTRP PUSCH, that is, some spatial data streams are sent to one TRP and other spatial data streams are sent to another TRP. Being sent to two TRPs destined herein may be described as using two beams to send two data streams. In this transmission mode, different ranks to be sent to two TRPs may be precoded by using a unified Transmit Precoding Matrix Indicator (TPMI)/channel Sounding Reference Signal Resource Indicator (SRI), or may be separately precoded by using two independent TPMIs/SRIs.

### (2) Codebook-Based PUSCH Transmission Mode:

A network side configures, for User Equipment (UE), a Sounding Reference Signal (SRS) resource set for codebook-based transmission, where each resource set includes at least one SRS resource. The UE sends an SRS based on at least one configured SRS resource. The network side receives the SRS to obtain an uplink channel, determines, based on this, a beam, a precoding matrix, a Modulation and coding scheme (MCS), and the like that are transmitted by an uplink data bearer channel PUSCH of the UE, and notifies the UE by using DCI.

The UE receives DCI for scheduling the PUSCH, and a TPMI field in the DCI selects, from a predefined codebook, a precoding matrix used for transmission of the scheduled PUSCH, as shown in Table 1. The UE performs precoding on uplink data based on the indicated TPMI and then maps the uplink data to a PUSCH resource for transmission.

TABLE 1
Precoding information and the number of layers, where for four antenna
ports, if a transform precoder is disabled, maxRank = 2 or 3 or 4.

| Bit field | | Bit field | Codebook | Bit field | |
|---|---|---|---|---|---|
| mapped | | mapped | subset = | mapped | Codebook |
| to index | All/Partial/ | to index | Partial/ | to index | subset = |
| value | Irrelevant | value | Irrelevant | value | Irrelevant |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 2 layers: TPMI = 0 | 4 | 2 layers: TPMI = 0 | 4 | 2 layers: TPMI = 0 |
| . . . | . . . | . . . | . . . | . . . | . . . |
| 9 | 2 layers: TPMI = 5 | 9 | 2 layers: TPMI = 5 | 9 | 2 layers: TPMI = 5 |
| 10 | 3 layers: TPMI = 0 | 10 | 3 layers: TPMI = 0 | 10 | 3 layers: TPMI = 0 |
| 11 | 4 layers: TPMI = 0 | 11 | 4 layers: TPMI = 0 | 11 | 4 layers: TPMI = 0 |
| 12 | 1 layer: TPMI = 4 | 12 | 1 layer: TPMI = 4 | 12-15 | reserved |
| . . . | . . . | . . . | . . . | | |
| 19 | 1 layer: TPMI = 11 | 19 | 1 layer: TPMI = 11 | | |
| 20 | 2 layers: TPMI = 6 | 20 | 2 layers: TPMI = 6 | | |
| . . . | . . . | . . . | . . . | | |
| 27 | 2 layers: TPMI = 13 | 27 | 2 layers: TPMI = 13 | | |
| 28 | 3 layers: TPMI = 1 | 28 | 3 layers: TPMI = 1 | | |
| 29 | 3 layers: TPMI = 2 | 29 | 3 layers: TPMI = 2 | | |
| 30 | 4 layers: TPMI = 1 | 30 | 4 layers: TPMI = 1 | | |
| 31 | 4 layers: TPMI = 2 | 31 | 4 layers: TPMI = 2 | | |
| 32 | 1 layers: TPMI = 12 | | | | |
| . . . | . . . | | | | |
| 47 | 1 layers: TPMI = 27 | | | | |
| 48 | 2 layers: TPMI = 14 | | | | |
| . . . | . . . | | | | |
| 55 | 2 layers: TPMI = 21 | | | | |
| 56 | 3 layers: TPMI = 3 | | | | |
| . . . | . . . | | | | |
| 59 | 3 layers: TPMI = 6 | | | | |
| 60 | 4 layers: TPMI = 3 | | | | |
| 61 | 4 layers: TPMI = 4 | | | | |
| 62-63 | reserved | | | | |

### (3) Non-Codebook-Based PUSCH Transmission Mode:

The network side configures, for the UE, an SRS resource set for non-codebook-based transmission, where each resource set includes at least one SRS resource. First, the UE detects, on a Non-Zero-Power (NZP) Channel State Information Reference Signal (CSI-RS) resource configured by the network side, an NZP CSI-RS sent by the network side, to obtain downlink channel state information. Based on channel reciprocity, the downlink channel information may be approximately equivalent to uplink channel information. The UE calculates, based on the uplink channel information, a candidate precoding matrix used for uplink transmission, and precodes and sends an SRS by using the precoding matrix. The network side further determines, based on the measured precoded SRS, a precoding matrix used for transmission of a PUSCH, and notifies the UE by scheduling DCI of the PUSCH.

As described in Table 2, an SRI (SRS resource indicator) field of the DCI selects a subset of an SRS resource index, that is, an SRI group, from a predefined SRI index table to notify the UE of a precoding matrix used for precoding of the PUSCH. An indicator example is shown in the following table, where N_{SRS} indicates the number of SRS resources in an SRS resource set.

TABLE 2
SRI indication for non-codebook based
PUSCH transmission, Lₘₐₓ = 4

| Bit field | | Bit field | | Bit field | |
|---|---|---|---|---|---|
| mapped | | mapped | | mapped | |
| to index | SRI(s), | to index | SRI(s), | to index | SRI(s), |
| value | N_{SRS} = 2 | value | N_{SRS} = 3 | value | N_{SRS} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | reserved | 3 | 0, 1 | 3 | 3 |
| | | 4 | 0, 2 | 4 | 0, 1 |
| | | 5 | 1, 2 | 5 | 0, 2 |
| | | 6 | 0, 1, 2 | 6 | 0, 3 |
| | | 7 | reserved | 7 | 1, 2 |
| | | | | 8 | 1, 3 |
| | | | | 9 | 2, 3 |
| | | | | 10 | 0, 1, 2 |
| | | | | 11 | 0, 1, 3 |
| | | | | 12 | 0, 2, 3 |
| | | | | 13 | 1, 2, 3 |
| | | | | 14 | 0, 1, 2, 3 |
| | | | | 15 | reserved |

### (4) Parameter Indicator of MTRP PUSCH Transmission

Currently, in an MTRP scenario, it is determined to configure two SRS resource sets, which are respectively corresponding to two TRPs. DCI for scheduling the PUSCH includes two SRI fields, and the two TPMI fields are respectively used to indicate two sets of parameters that are simultaneously used for transmission of the PUSCH. Two SRI fields correspondingly indicate SRS resources in two SRS resource sets, and each SRS resource corresponds to one beam. In this way, the PUSCH can be sent by using two beams at the same time, thereby improving data transmission reliability.

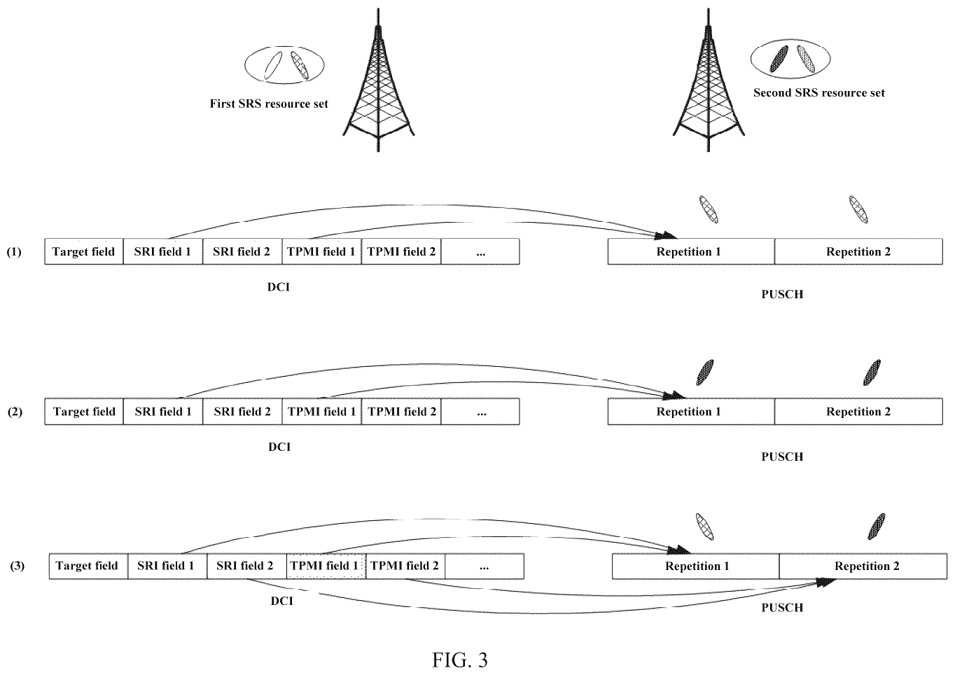

In addition, to improve flexibility of MTRP transmission, a target field is introduced into the DCI, and is used to indicate which one or two of current two TRPs is/are used as a target TRP for transmission of the PUSCH, as shown in FIG. 3.

In FIG. 3, when a target field is “00”, as shown in case (1) in FIG. 3, only the first SRI field and the first TPMI field are used, and the first SRI field corresponds to the first SRS resource set (SRS resource set 1), that is, a TRP 1 is sent in both two repetitions.

When the target field is “01”, as shown in case (2) in FIG. 3, only the first SRI field and the first TPMI field are used, and the first SRI field corresponds to the second SRS resource set (SRS resource set 2), that is, a TRP 2 is sent in both two repetitions.

When the target field is “10”, as shown in case (3) in FIG. 3, the first SRI field and the first TPMI field correspond to the first SRS resource set (SRS resource set 1), the second SRI field and the second TPMI field correspond to the second SRS resource set (SRS resource set 2), that is, a TRP 1 is sent by using the first beam in the first repetition, and a TRP 2 is sent by using the second beam in the second repetition.

### (5) DMRS Code Domain Multiplexing (CDM) Group

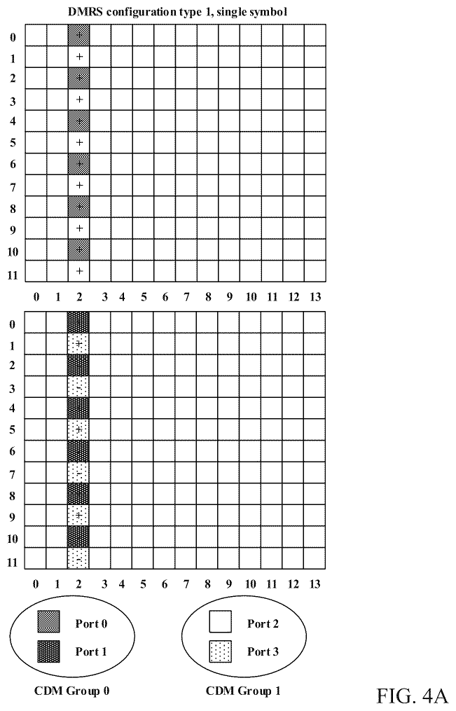

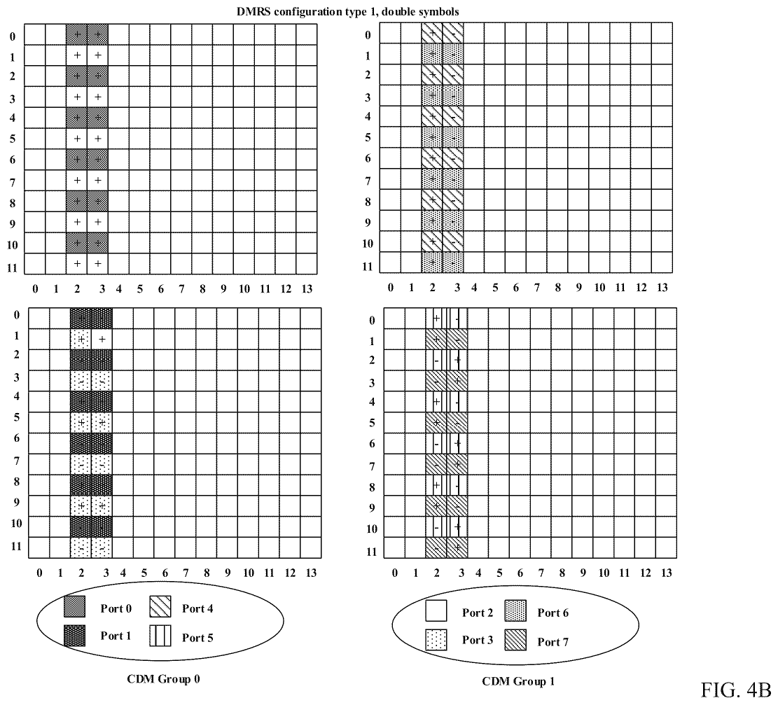

As shown in FIG. 4A and FIG. 4B, it can be learned from FIG. 4A and FIG. 4B that DMRS ports belonging to a same DMRS CDM group occupy a same time-frequency resource.

A reference signal port indication method, a terminal, and a network side device provided in the embodiments of this application are described below by using specific embodiments and application scenarios thereof with reference to the accompanying drawings.

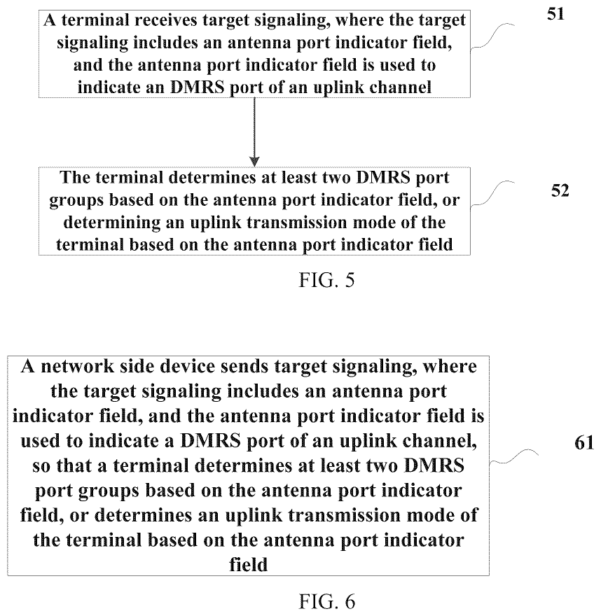

As shown in FIG. 5, an embodiment of this application provides a reference signal port indication method. The method includes the following steps.

Step 51: A terminal receives target signaling, where the target signaling includes an antenna port indicator field, and the antenna port indicator field is used to indicate an DMRS port of an uplink channel.

The target signaling may be DCI signaling.

The uplink channel may be, for example, a PUSCH.

Step 52: The terminal determines at least two DMRS port groups based on the antenna port indicator field, or determining an uplink transmission mode of the terminal based on the antenna port indicator field.

In this embodiment of this application, each DMRS port group includes at least one DMRS port.

In this embodiment of this application, the at least two DMRS port groups may be different DMRS port groups, or may be identical DMRS port groups.

In this embodiment of this application, the terminal can determine at least two DMRS port groups, or determine an uplink transmission mode of the terminal based on the DMRS port used for the uplink channel and indicated by the antenna port indicator field. Because at least two DMRS port groups are determined, PUSCHs sent by using different beams in an MTRP scenario may correspondingly use DMRS ports in different DMRS port groups. When different time-frequency resources are used for DMRS ports in different DMRS port groups, mutual interference can be reduced, and transmission performance of uplink data is improved.

An indication manner of the antenna indicator field is described in detail below.

1. The target signaling includes one antenna port indicator field and one or more first indicator fields, and the antenna port indicator field is used to indicate a plurality of DMRS ports.

That the terminal determines at least two DMRS port groups based on the antenna port indicator field includes: The terminal determines the at least two DMRS port groups based on a target rank and the antenna port indicator field, where the target rank is determined based on a rank indicated by the first indicator field. In other words, the antenna port indicator field is interpreted based on the target rank.

In this embodiment of this application, the first indicator field may be precoding information and number of layers (TPMI) or an SRS resource indicator (SRI) field, or may be another indicator field used to specifically indicate a rank of the uplink channel.

In some embodiments, the target signaling may include one first indicator field, the target rank is equal to a rank indicated by the first indicator field by one multiple, for example, if two DMRS port groups are determined, the target rank is equal to the rank indicated by the first indicator field by 2.

In some embodiments, the target signaling may include a plurality of first indicator fields.

### (1) The Target Rank is a Sum of Ranks Indicated by the Plurality of First Indicator Fields.

For example, when the first indicator field is a TPMI indicator field, and the target signaling includes two TPMI indicator fields, the target rank is a sum of ranks indicated by the two TPMI indicator fields, and the rank herein may also be described as a layer. In some embodiments, when the first indicator field is an SRI indicator field, and the target signaling includes two SRI indicator fields, the target rank is a sum of ranks indicated by the two SRI indicator fields, that is, the total number of SRSs groups indicated by the two SRI fields.

In some embodiments, the sum of the ranks indicated by the plurality of first indicator fields does not exceed a maximum rank limit.

In some embodiments, the maximum rank limit is indicated by a network side device by using RRC signaling or a MAC CE.

In some embodiments, in the at least two DMRS port groups, DMRS ports belonging to different DMRS port groups are from different DMRS CDM groups. For example, DMRS ports in a same DMRS port group are from a same DMRS CDM group.

In some embodiments, the first indicator field is a valid indicator field. In other words, the target rank is interpreted by using the valid first indicator field.

(2) In Some Embodiments, the Target Rank is a Relatively Large Rank in Ranks Indicated by the plurality of first indicator fields.

In some embodiments, the first Y ports in a plurality of DMRS ports indicated by the antenna port indicator field are DMRS ports corresponding to a target first indicator field, and the target first indicator field is a first indicator field that is in the plurality of first indicator fields and that indicates a relatively small rank.

In some embodiments, the first indicator field is a valid indicator field. In other words, the target rank is interpreted by using the valid first indicator field.

(3) In Some Embodiments, the Target Rank is a Rank Indicated by the First First Indicator field in the plurality of first indicator fields.

In some embodiments, the first indicator field is a valid indicator field. In other words, the target rank is interpreted by using the valid first indicator field.

In this embodiment of this application, that the terminal determines at least two DMRS port groups based on a target rank and the antenna port indicator field includes: The terminal classifies, based on the target rank, a plurality of DMRS ports indicated by the antenna port indicator field into the at least two DMRS port groups.

In some embodiments, that the terminal classifies, based on the target rank, a plurality of DMRS ports indicated by the antenna port indicator field into the at least two DMRS port groups includes:
the terminal classifies the plurality of DMRS ports into the at least two DMRS port groups based on an index value of a DMRS port, where a port index of a DMRS port in a DMRS port group is less than a port index of a DMRS port in a subsequent DMRS port group, for example, the terminal classifies the plurality of DMRS ports into two DMRS port groups based on the index value of the DMRS port, where a port index of a DMRS port in the first DMRS port group is less than a port index of a DMRS port in the second DMRS port group;
or
the terminal classifies the plurality of DMRS ports into the at least two DMRS port groups based on arrangement locations of the plurality of DMRS ports, where in this embodiment of this application, the plurality of DMRS ports indicated by the antenna port indicator field are not necessarily arranged based on index values;
or
the terminal classifies the plurality of DMRS ports into the at least two DMRS port groups based on the plurality of DMRS ports and DMRS CDM groups to which the plurality of DMRS ports respectively belong, where DMRS ports belonging to a same DMRS port group are one DMRS port group.

In this embodiment of this application, each DMRS port group corresponds to one first indicator field;
or
each DMRS port group corresponds to a rank indicator parameter indicated by one first indicator field; where
first indicator fields corresponding to different DMRS port groups are different.

In this embodiment of this application, the target signaling further includes a first target indicator field, and the first target indicator field is used to indicate a first indicator field corresponding to the rank indicator parameter. The rank indicator parameter may be a TPMI or an SRI. Further, ranks indicated by first indicator fields are the same. For example, when the first target indicator field is a first value, the first rank indicator parameter is indicated by the first first indicator field, and the second rank indicator parameter is indicated by the second first indicator field; and when the first target indicator field is a second value, the first rank indicator parameter is indicated by the second first indicator field, and the second rank indicator parameter is indicated by the first first indicator field.

In some embodiments, the foregoing first relationship (each DMRS port group corresponds to one first indicator field) and the foregoing second relationship (each DMRS port group corresponds to a rank indicator parameter indicated by one first indicator field) are used when the following condition is met: Ranks indicated by the two first indicator fields are the same.

In some other embodiments of this application, a target DMRS port group in the at least two DMRS port groups corresponds to a target first indicator field in the plurality of first indicator fields, and a rank indicated by the target first indicator field is equal to the number of DMRS ports in the target DMRS port group.

Further, the foregoing relationship (the target DMRS port group in the at least two DMRS port groups corresponds to the target first indicator field in the plurality of first indicator fields) is used when the following condition is met: Ranks indicated by the plurality of first indicator fields are different.

For example, the target signaling includes two first indicator fields, and the terminal determines two DMRS port groups based on the antenna port indicator fields.

The first DMRS port group corresponds to the first first indicator field, and the second DMRS port group corresponds to the second first indicator field; for example, the first DMRS port group corresponds to the first TMPI indicator field, and the second DMRS port group corresponds to the second TMPI indicator field; or the first DMRS port group corresponds to the first SRI indicator field, and the second DMRS port group corresponds to the second SRI indicator field;
or
the first DMRS port group corresponds to the first rank indicator parameter, and the second DMRS port group corresponds to the second rank indicator parameter, where the first rank indicator parameter is indicated by one of the first first indicator field or the second first indicator field, and the second rank indicator parameter is indicated by the other of the first first indicator field and the second first indicator field. The rank indicator parameter may be a TMPI or an SRI. For example, the first DMRS port group corresponds to the first TMPI, and the second DMRS port group corresponds to the second TMPI, where the first TMPI is indicated by one of the first TMPI indicator field or the second TMPI indicator field, and the second TMPI is indicated by the other of the first TMPI indicator field and the second TMPI indicator field; or the first DMRS port group corresponds to the first SRI, and the second DMRS port group corresponds to the second SRI, where the first SRI is indicated by one of the first SRI indicator field or the second SRI indicator field, and the second SRI is indicated by the other of the first SRI indicator field and the second SRI indicator field.

A meaning of “corresponds to” is that the number of DMRS ports in the DMRS port group is determined by a corresponding first indicator field or a rank indicated by a rank indicator parameter.

2. The target signaling includes one antenna port indicator field and at least two first indicator fields, the antenna port indicator field is used to indicate at least two DMRS port groups, and each DMRS port group includes at least one DMRS port.

In this embodiment of this application, the antenna port indicator field uses one codepoint to indicate the at least two DMRS port groups.

Further, the target signaling further includes one or more first indicator fields, the antenna port indicator field indicates two DMRS port groups by using one codepoint, and the second DMRS port group is interpreted by a rank indicated by the second first indicator field.

Further, in the at least two DMRS port groups, DMRS ports belonging to different DMRS port groups are from different DMRS CDM groups.

In this embodiment of this application, each DMRS port group corresponds to one first indicator field;
or
each DMRS port group corresponds to a rank indicator parameter indicated by one first indicator field; where
first indicator fields corresponding to different DMRS port groups are different.

In this embodiment of this application, the target signaling further includes a first target indicator field, and the first target indicator field is used to indicate a first indicator field corresponding to the rank indicator parameter. The rank indicator parameter may be a TMPI or an SRI. Further, ranks indicated by first indicator fields are the same. For example, when the first target indicator field is a first value, the first rank indicator parameter is indicated by the first first indicator field, and the second rank indicator parameter is indicated by the second first indicator field; and when the first target indicator field is a second value, the first rank indicator parameter is indicated by the second first indicator field, and the second rank indicator parameter is indicated by the first first indicator field.

In some embodiments, the foregoing first relationship (each DMRS port group corresponds to one first indicator field) and the foregoing second relationship (each DMRS port group corresponds to a rank indicator parameter indicated by one first indicator field) are used when the following condition is met: Ranks indicated by the two first indicator fields are the same.

In some other embodiments of this application, a target DMRS port group in the at least two DMRS port groups corresponds to a target first indicator field in the plurality of first indicator fields, and a rank indicated by the target first indicator field is equal to the number of DMRS ports in the target DMRS port group.

Further the foregoing relationship (the target DMRS port group in the at least two DMRS port groups corresponds to the target first indicator field in the plurality of first indicator fields) is used when the following condition is met: Ranks indicated by the plurality of first indicator fields are different.

3. That the terminal determines at least two DMRS port groups based on the antenna port indicator field includes: The terminal determines the at least two DMRS port groups based on the antenna indicator field and a DMRS combination table, where the DMRS port combination table includes a first DMRS port combination table or a second DMRS port combination table, the first DMRS port combination table includes a first DMRS port set, and the second DMRS port combination table does not include the first DMRS port set.

In some embodiments, that the terminal determines the at least two DMRS port groups based on the first DMRS port combination table includes:
if a first target indicator field does not exist in the target signaling, the terminal determines at least two DMRS port groups based on the first DMRS port combination table; and
if the first target indicator field exists in the target signaling, the terminal determines at least two DMRS port groups based on a second DMRS port combination table.

In some embodiments, the first DMRS port set may include at least one of the following: {0, 2, 3}.

In some embodiments, the first DMRS port set may include at least one of the following: {0, 2, 3, 6} and {0, 1, 4, 2}.

In some embodiments, the first DMRS port set may include at least one of the following: {0, 1, 2, 4} and {0, 2, 3, 4}.

In some embodiments, the first DMRS port set may include at least one of the following: {0, 2, 3, 8}, {0, 4, 5, 10}, {0, 1, 6, 2}, {0, 1, 6, 4}, {2, 3, 8, 4}, and {2, 4, 5, 10}.

In the foregoing manner, it can be ensured that there is a combination whose target rank is 1+2/1+3/3+1, so that different numbers of data streams are separately sent by using two beams.

In this embodiment of this application, the foregoing solution 1 and solution 3 may also be used together. In other words, a used DMRS port combination table is first determined based on the target rank and the first target indicator field. Then, based on the solution 1, the terminal classifies, based on the target rank, the plurality of DMRS ports in the DMRS port combination table that are indicated by the antenna port indicator field into the at least two DMRS port groups.

4. The target signaling includes a plurality of antenna port indicator fields, and each antenna port indicator field is used to indicate one DMRS port group.

In this embodiment of this application, DMRS ports in the DMRS port group that are indicated by different antenna port indicator fields correspond to different DMRS CDM groups.

In this embodiment of this application, the target signaling includes two antenna port indicator fields, the target signaling further includes two first indicator fields, and the second antenna port indicator field is associated with the second first indicator field.

In this embodiment of this application, the target signaling further includes one or more first indicator fields, the target signaling includes two antenna port indicator fields, and the second antenna port indicator field is determined based on a target rank indicator parameter indicated by a target first indicator field.

In this embodiment of this application, the target signaling further includes a first target indicator field, and the target rank indicator parameter is determined by using the first target indicator field. The rank indicator parameter may be a TPMI or an SRI.

For example, when the first target indicator field is a first value, a target TPMI or SRI is indicated by the first TPMI or SRI indicator field; and when the first target indicator field is a second value, the target TPMI or SRI is indicated by the second TPMI or SRI.

5. The target signaling includes one antenna port indicator field, and the antenna port indicator field is used to indicate one DMRS port group. The terminal implicitly obtains another DMRS port group based on a DMRS port group indicated by the antenna port indicator field.

In some embodiments, the first DMRS port group in the at least two DMRS port groups is the DMRS port group indicated by the antenna port indicator field, and remaining DMRS port groups are implicitly obtained based on the DMRS port group indicated by the antenna port indicator field.

In some embodiments, the remaining DMRS port groups are the same as the first DMRS port group.

In some embodiments, the remaining DMRS port groups are obtained in the following manner:
a DMRS CDM group corresponding to the first DMRS port group; and
a sequence of DMRS CDM groups corresponding to the first DMRS port group.

For example, if all DMRS ports in the first DMRS port group belong to the first DMRS CDM group, for example, a CDM group 0, a DMRS port in the second DMRS port group is from a neighboring second DMRS CDM group, for example, a CDM group 1.

In this embodiment of this application, that the terminal determines at least two DMRS port groups based on the antenna port indicator field further includes: The terminal obtains an association relationship between a phase-tracking reference signal (PTRS) port and a DMRS port group, where the association relationship between a PTRS port and a DMRS port group is one of the following:
a plurality of PTRS ports are separately associated with at least two DMRS port groups, for example, two PTRS ports are separately associated with two DMRS port groups;
a plurality of PTRS ports are separately associated with a plurality of DMRS CDM groups, for example, two PTRS ports are separately associated with two DMRS CDM groups;
a plurality of PTRS ports correspond to a target DMRS port group, and the target DMRS port group is a DMRS port group with the largest MCS in the at least two DMRS port groups; or
one PTRS port is associated with the at least two DMRS port groups.

In this embodiment of this application, the target signaling further includes a PTRS-DMRS association field, and the PTRS-DMRS association field is used to indicate that a PTRS port is associated with a target DMRS port in an associated DMRS port group.

In this embodiment of this application, a bit length of the PTRS-DMRS association field is X bits.

The PTRS-DMRS association field is used to indicate the target DMRS port is associated with a target PTRS port in a target DMRS port group, the target DMRS port group is a DMRS port group with a larger number of DMRS ports, and the target PTRS port is a PTRS port associated with the target DMRS port group.

In some embodiments, in a first transmission mode, the PTRS-DMRS association field is used to indicate that the target PTRS port is associated with a target DMRS port in a group of DMRS port groups, and the target PTRS port is a PTRS port associated with the DMRS port group.

In this embodiment of this application, the X bits of the PTRS-DMRS association field are divided into two parts respectively correspondingly indicating that two PTRS ports are associated with target DMRS ports in corresponding two groups of DMRS ports.

In this embodiment of this application, that the PTRS-DMRS association field corresponds to the DMRS port group with a larger number of DMRS ports is valid when at least one of the following conditions is met:
numbers of the two groups of DMRS ports are not equal; or
ranks indicated by two first indicator fields are not equal.

In this embodiment of this application, that the X bits of the PTRS-DMRS association field are divided into two parts respectively correspondingly indicating that two groups of DMRS port indicator fields is valid when at least one of the following conditions is met:
numbers of the two groups of DMRS ports are equal; or
ranks indicated by two first indicator fields are equal.

For example, a network side configures that a maximum number of PTRS ports is 2, numbers of ranks indicated by two TPMI ports or two SRIs are unequal, and numbers of two groups of DMRS ports indicated by a DMRS port indicator field are unequal. In this case, the bit length of the PTRS-DMRS association field is a DMRS port group with a large quantity corresponding to two bits, that is, one DMRS port is selected from the DMRS port group with a large quantity to be associated with the target PTRS port, and the target PTRS port is a PTRS port associated with a DMRS port with a large quantity or an SRI/TPMI with a large rank.

In this embodiment of this application, DMRS ports in one DMRS port group share one associated PTRS port.

In this embodiment of this application, DMRS ports in one DMRS port group are from a same DMRS CDM group.

In this embodiment of this application, the terminal determines the uplink transmission mode of the terminal based on the antenna port indicator field, where the uplink transmission mode is a first transmission mode or a third transmission mode, the first transmission mode is to send a PUSCH by using one beam, and the third transmission mode is to send a PUSCH through Time-Division Multiplexing (TDM) of a plurality of beams, that is, different beams are used to send the PUSCH in different transmission occasions.

In this embodiment of this application, the target signaling further includes a plurality of first indicator fields, and rank indicator parameters corresponding to one beam in the first transmission mode are indicated by the first first indicator field.

In this embodiment of this application, the target signaling further includes a plurality of SRI indicator fields, one beam in the first transmission mode is the first beam, and the first beam is a spatial relationship or the first TCI state associated with an SRS resource indicated by the first SRI indicator field.

In this embodiment of this application, one beam in the first transmission mode uses the first Transmission Configuration Indicator (TCI) state, and the first TCI state is indicated by other signaling.

In this embodiment of this application, when the first transmission mode is used, the first Y DMRS ports in Z DMRS ports indicated by the antenna port indicator field are valid DMRS ports, and Y is a rank indicated by the first indicator field. In some embodiments, Y is a rank indicated by the first first indicator field.

In this embodiment of this application, the first transmission mode is used when at least one of the following conditions is met:
the number of layers of precoding indicated by the first indicator field is 1;
the first target indicator field indicates that one beam is used for transmission;
the antenna port indicator field indicates a reserved codepoint; or
DMRS ports in a same DMRS port group belong to a same DMRS CDM group.

In this embodiment of this application, when the antenna port indicator field indicates a reserved codepoint, DMRS ports indicated by the antenna port indicator field are 0 to L−1, and L is a rank indicated by the first indicator field.

In this embodiment of this application, the first DMRS port group indicated by the antenna port indicator field takes effect.

In this embodiment of this application, the third transmission mode is used when at least one of the following conditions is met:
the first target indicator field indicates that two beams are used for transmission; or
DMRS ports indicated by the antenna indicator field belong to one CDM group.

In this embodiment of this application, the terminal determines the uplink transmission mode of the terminal based on the antenna port indicator field, where the uplink transmission mode is a second transmission mode, and the second transmission mode is to simultaneously send a PUSCH by using a plurality of beams. The second transmission mode may be one of Space Division Multiplexing (SDM), Single Frequency Network (SFN), or Frequency Division Multiplexing (FDM), where SDM indicates that different spatial streams are sent by using different beams.

The target signaling further includes one or more first indicator fields, and sending a PUSCH by using a plurality of beams includes:
sending the PUSCH by using two beams, where
M layers of the PUSCH are sent by using one beam, and N layers are sent by using another beam; where

$$M = ⌈ A / 2 ⌉ orM = ⌊ A / 2 ⌋ ;$$

$$N = A - M ;$$

and
A is a value of a total rank indicated by the first indicator field.

In this embodiment of this application, the target signaling includes two first indicator fields; and
M and N are ranks indicated by the two first indicator fields respectively;
or
M and N are determined by two DMRS port groups.

In this embodiment of this application, M and N are determined by two DMRS port groups, DMRS ports in the two DMRS port groups are separately from two DMRS CDM groups, M is the number of DMRS ports in the first DMRS CDM group, and N is the number of DMRS ports in the second DMRS CDM group.

In this embodiment of this application, the second transmission mode is used when the following condition is met: DMRS ports in the at least two DMRS port groups are from at least two DMRS CDM groups.

In this embodiment of this application, the plurality of beams are mapped to the at least two DMRS port groups.

In some embodiments, the plurality of DMRS port groups include the first DMRS port group having a DMRS port with a smallest index.

In this embodiment of this application, a mapping sequence of the beams and the DMRS port groups is indicated by a first target indicator field in the target signaling.

In some embodiments, the first DMRS port group corresponds to the first beam.

In this embodiment of this application, the number of beams used by the terminal to send the PUSCH is indicated by a network side by using RRC configuration or DCI. For example, the number of beams used by the terminal to send the PUSCH is indicated by using a first target field.

In this embodiment of this application, a beam refers to an SRS, a spatial relationship, a TCI state, or a reference signal of a QCL type D.

In this embodiment of this application, the first target indicator field exists when at least one of the following conditions is met:
at least two SRS resource sets are configured;
a fourth transmission mode is configured, where the fourth transmission mode is a frequency division multiplexing manner or a transmission manner in which transmission of the PUSCH is associated with at least two target resources;
a fifth transmission mode is not configured, where the fifth transmission mode is a space division multiplexing manner;
at least one codepoint in a TCI indicator field is associated with two TCI states used for uplink transmission; or
there are two currently effective TCI states used for uplink transmission.

The target resource is, for example, a spatial relationship, an SRS, a TCI state, a panel, a TPMI, or the like.

In some embodiments, a bit length of the first target indicator field is 1 bit when at least one of the following conditions is met:
at least two SRS resource sets are configured;
a fifth transmission mode is configured, where the fifth transmission mode is a space division multiplexing manner.

As shown in Table 3, Table 3 is a relationship among a beam quantity, a TPMI quantity, and the number of two groups of DMRS port groups indicated by the target signaling.

TABLE 3

| Beam | TPMI | Number of indicated | |
|---|---|---|---|
| quantity | quantity | DMRS groups | Behavior |
| 1 | 1 | 1 | Legacy |
| 1 | 1 | 2 | Both groups use one beam. |
| 1 | 2 | 1 | This case is not expected. |
| 1 | 2 | 2 | Both groups use one beam. |
| 2 | 1 | 1 | The first beam is used. |
| 2 | 1 | 2 | One beam is used |
| | | | respectively. |
| 2 | 2 | 1 | A common group of |
| | | | DMRS ports are shared. |
| 2 | 2 | 2 | One beam is used |
| | | | respectively. |

As shown in FIG. 6, an embodiment of this application further provides a reference signal port indication method. The method includes the following steps.

Step 61: A network side device sends target signaling, where the target signaling includes an antenna port indicator field, and the antenna port indicator field is used to indicate a DMRS port of an uplink channel, so that a terminal determines at least two DMRS port groups based on the antenna port indicator field, or determines an uplink transmission mode of the terminal based on the antenna port indicator field.

The target signaling includes one antenna port indicator field, and the antenna port indicator field is used to indicate a plurality of DMRS ports;
or
the target signaling includes one antenna port indicator field, and the antenna port indicator field is used to indicate at least two DMRS ports;
or
the target signaling includes a plurality of antenna port indicator fields, and each antenna port indicator field is used to indicate one DMRS port;
or
the target signaling includes one antenna port indicator field, the antenna port indicator field is used to indicate one DMRS port group, the first DMRS port group in the at least two DMRS port groups is the DMRS port group indicated by the antenna port indicator field, and remaining DMRS port groups are implicitly obtained based on the DMRS port group indicated by the antenna port indicator field.

Embodiment 1 of this application:

In this embodiment of this application, a network side sends DCI to the terminal. The DCI includes the antenna port indicator field and two first indicator fields. When ranks indicated by the two first indicator fields are separately 2 and 2, the antenna port indicator field corresponds to an interpretation that a rank is equal to 4. When a value of the antenna port indicator field is 0, corresponding DMRS port sets are 0 to 3 based on Table 4, where DMRS ports 0 and 1 belong to one CDM group, and DMRS ports 2 and 3 belong to one CDM group. In this case, the two CDM groups are two DMRS port groups.

TABLE 4
Antenna port, transform precoder disabled, DMRS type =
2, maxLength = 2, rank = 4

| | Number of DMRS | | Number of |
|---|---|---|---|
| | CDM group (s) | DMRS | front-load |
| Value | without data | port (s) | symbols |
| 0 | 2 | 0-3 | 1 |
| 1 | 3 | 0-3 | 1 |
| 2 | 3 | 0, 1, 6, 7 | 2 |
| 3 | 3 | 2, 3, 8, 9 | 2 |
| 4 | 3 | 4, 5, 10, 11 | 2 |
| 5-31 | Reserved | Reserved | Reserved |

In some embodiments, if the value of the antenna port indicator field is 2, based on Table 4, a corresponding DMRS port set is {0, 1, 6, 7}, where {0, 1} is the first DMRS port group, and {6, 7} is the second DMRS port group.

Embodiment 2 of this application:

In this embodiment of this application, a network side sends DCI to the terminal. The DCI includes the antenna port indicator field, and one codepoint of the antenna port indicator field corresponds to two DMRS port groups: DMRS port(s) and DMRS port(s) 2 that respectively correspondingly use transmission layers of different beams.

TABLE 5
Antenna port, transform precoder enabled, dmrs type =
1, maximum length = 2, except that both dmrs
uplink transform precoding and tp-pi2BPSK are
configured and π/2-BPSK modulation is used

| | Number of DMRS | | | Number of |
|---|---|---|---|---|
| | CDM group (s) | DMRS | DMRS | front-load |
| Value | without data | port (s) | port (s) 2 | symbols |
| 0 | 2 | 0 | 2 | 1 |
| 1 | 2 | 1 | 3 | 1 |
| 2 | 2 | 2 | 0 | 1 |
| 3 | 2 | 3 | 1 | 1 |
| 4 | 2 | 0 | 2 | 2 |
| 5 | 2 | 1 | 3 | 2 |
| 6 | 2 | 2 | 0 | 2 |
| 7 | 2 | 3 | 1 | 2 |
| 8 | 2 | 4 | 6 | 2 |
| 9 | 2 | 5 | 7 | 2 |
| 10 | 2 | 6 | 4 | 2 |
| 11 | 2 | 7 | 5 | 2 |
| 12-15 | Reserved | Reserved | Reserved | Reserved |

Embodiment 3 of this application:

In this embodiment of this application, a network side sends DCI to the terminal. The DCI includes the antenna port indicator field, and DMRS ports indicated by the antenna port indicator field are from two CDM groups. Therefore, a two-bit interpretation of a PTRS-DMRS association field is shown in Table 6.

TABLE 6

| Value | | Value | |
|---|---|---|---|
| of MSB | | of LSB | |
| (highest | DMRS | (lowest | DMRS |
| bit) | port | bit) | port |
| 0 | The first DMRS | 0 | The first DMRS |
| | port in the | | port in the |
| | first CDM group | | second CDM group |
| 1 | The second DMRS | 1 | The second DMRS |
| | port in the | | port in the |
| | first CDM group | | second CDM group |

Embodiment 4 of this application:

In this embodiment of this application, a network side sends DCI to the terminal. The DCI includes the antenna port indicator field and a TPMI indicator field. When the TPMI indicator field indicates rank=3 and a first target indicator field does not exist in the DCI, the terminal determines at least two DMRS port groups based on a first DMRS port combination table. A first DMRS port combination table includes a first DMRS port set {0, 2, 3}. Refer to Table 7 to Table 11.

TABLE 7
Antenna port, transform precoder disabled, dmrs type =
1, maxLength = 1, rank = 3

| | Number of DMRS | |
|---|---|---|
| | CDM group (s) | DMRS |
| Value | without data | port (s) |
| 0 | 2 | 0-2 |
| 1 | 2 | 0, 2, 3 |
| 2-7 | Reserved | Reserved |

TABLE 8
Antenna port, transform precoder disabled, dmrs type =
1, maxLength = 2, rank = 3

| | Number of DMRS | | Number of |
|---|---|---|---|
| | CDM group (s) | DMRS | front-loaded |
| Value | without data | port (s) | symbols |
| 0 | 2 | 0-2 | 1 |
| 1 | 2 | 0, 1, 4 | 2 |
| 2 | 2 | 2, 3, 6 | 2 |
| 3 | 2 | 0, 2, 3 | 1 |
| 4-15 | Reserved | Reserved | Reserved |

TABLE 9
Antenna port, transform precoder disabled, dmrs type =
2, maxLength = 1, rank = 3

| Value | Number of DMRS CDM group (s) without data | DMRS port (s) |
|---|---|---|
| 0 | 2 | 0-2 |
| 1 | 3 | 0-2 |
| 2 | 3 | 3-5 |
| 3 | 3 | 0, 2, 3 |
| 4-15 | Reserved | Reserved |

TABLE 10
Antenna port, transform precoder disabled, dmrs type =
2, maxLength = 1, rank = 3

| Value | Number of DMRS CDM group (s) without data | DMRS port (s) |
|---|---|---|
| 0 | 2 | 0-2 |
| 1 | 3 | 0-2 |
| 2 | 3 | 3-5 |
| 3 | 2 | 0, 2, 3 |
| 4 | 3 | 0, 2, 3 |
| 5-15 | Reserved | Reserved |

TABLE 11
Antenna port, transform precoder disabled, dmrs type =
2, maxLength = 2, rank = 3

| | Number of DMRS | | Number of |
|---|---|---|---|
| | CDM group (s) | DMRS | front-load |
| Value | without data | port (s) | symbols |
| 0 | 2 | 0-2 | 1 |
| 1 | 3 | 0-2 | 1 |
| 2 | 3 | 3-5 | 1 |
| 3 | 3 | 0, 1, 6 | 2 |
| 4 | 3 | 2, 3, 8 | 2 |
| 5 | 3 | 4, 5, 10 | 2 |
| 6 | 6 | 0, 2, 3 | 1 |
| 7-31 | Reserved | Reserved | Reserved |

When the first target indicator field exists, the terminal determines at least two DMRS port groups based on a second DMRS port combination table. The second DMRS port combination table does not include a first DMRS port set {0, 2, 3}. Refer to Table 12 to Table 16.

TABLE 12
Antenna port, transform precoder disabled, dmrs type =
1, maxLength = 1, rank = 3

| | Number of DMRS | |
|---|---|---|
| | CDM group (s) | DMRS |
| Value | without data | port (s) |
| 0 | 2 | 0-2 |
| 1-7 | Reserved | Reserved |

TABLE 13
Antenna port, transform precoder disabled, dmrs type =
1, maxLength = 2, rank = 3

| | Number of DMRS | | Number of |
|---|---|---|---|
| | CDM group (s) | DMRS | front-load |
| Value | without data | port (s) | symbols |
| 0 | 2 | 0-2 | 1 |
| 1 | 2 | 0, 1, 4 | 2 |
| 2 | 2 | 2, 3, 6 | 2 |
| 3-15 | Reserved | Reserved | Reserved |

TABLE 14
Antenna port, transform precoder disabled, dmrs type =
2, maxLength = 1, rank = 3

| Value | Number of DMRS CDM group (s) without data | DMRS port (s) |
|---|---|---|
| 0 | 2 | 0-2 |
| 1 | 3 | 0-2 |
| 2 | 3 | 3-5 |
| 4-15 | Reserved | Reserved |

TABLE 15
Antenna port, transform precoder disabled, dmrs type =
2, maxLength = 1, rank = 3

| Value | Number of DMRS CDM group (s) without data | DMRS port (s) |
|---|---|---|
| 0 | 2 | 0-2 |
| 1 | 3 | 0-2 |
| 2 | 3 | 3-5 |
| 3-15 | Reserved | Reserved |

TABLE 16
Antenna port, transform precoder disabled, dmrs type =
2, maxLength = 2, rank = 3

| | Number of DMRS CDM group (s) | DMRS | Number of front- |
|---|---|---|---|
| Value | without data | port (s) | load symbols |
| 0 | 2 | 0-2 | 1 |
| 1 | 3 | 0-2 | 1 |
| 2 | 3 | 3-5 | 1 |
| 3 | 3 | 0, 1, 6 | 2 |
| 4 | 3 | 2, 3, 8 | 2 |
| 5 | 3 | 4, 5, 10 | 2 |
| 6-31 | Reserved | Reserved | Reserved |

The reference signal port indication method provided in the embodiments of this application may be performed by a reference signal port indication apparatus. In this embodiment of this application, an example in which the reference signal port indication method is performed by a reference signal port indication apparatus is used to describe the reference signal port indication apparatus provided in the embodiments of the application.

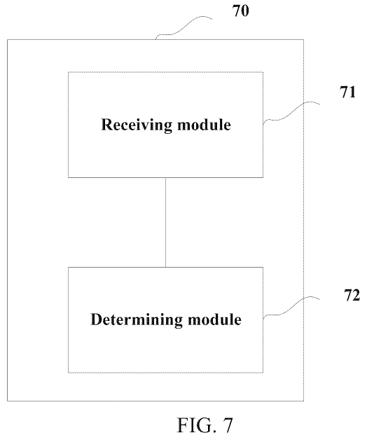

As shown in FIG. 7, an embodiment of this application further provides a reference signal port indication apparatus 70, including:
a receiving module 71, configured to receive target signaling, where the target signaling includes an antenna port indicator field, and the antenna port indicator field is used to indicate a DMRS port of an uplink channel; and
a determining module 72, configured to determine at least two DMRS port groups based on the antenna port indicator field, or determine an uplink transmission mode of a terminal based on the antenna port indicator field.

In this embodiment of this application, the terminal can determine at least two DMRS port groups, or determine an uplink transmission mode of the terminal based on the DMRS port used for the uplink channel and indicated by the antenna port indicator field. Because at least two DMRS port groups are determined, PUSCHs sent by using different beams in an MTRP scenario may correspondingly use DMRS ports in different DMRS port groups. When different time-frequency resources are used for DMRS ports in different DMRS port groups, mutual interference can be reduced, and transmission performance of uplink data is improved.

In some embodiments, the target signaling includes one antenna port indicator field and one or more first indicator fields, and the antenna port indicator field is used to indicate a plurality of DMRS ports.

The determining module 72 is configured to determine the at least two DMRS port groups based on a target rank and the antenna port indicator field, where the target rank is determined based on a rank indicated by the first indicator field.

In some embodiments, the target rank is a sum of ranks indicated by the plurality of first indicator fields;
or
   the target rank is a relatively large rank in ranks indicated by the plurality of first indicator fields;
   or
   the target rank is a rank indicated by the first first indicator field in the plurality of first indicator fields.

In some embodiments, the first indicator field is a valid indicator field.

In some embodiments, the sum of the ranks indicated by the plurality of first indicator fields does not exceed a maximum rank limit.

In some embodiments, the determining module 72 is configured to group, based on the target rank, a plurality of DMRS ports indicated by the antenna port indicator field into the at least two DMRS port groups.

In some embodiments, the grouping, based on the target rank, a plurality of DMRS ports indicated by the antenna port indicator field into the at least two DMRS port groups includes:
grouping the plurality of DMRS ports into the at least two DMRS port groups based on an index value of a DMRS port, where a port index of a DMRS port in a DMRS port group is less than a port index of a DMRS port in a subsequent DMRS port group;
or
grouping the plurality of DMRS ports into the at least two DMRS port groups based on arrangement locations of the plurality of DMRS ports;
or
grouping the plurality of DMRS ports into the at least two DMRS port groups based on the plurality of DMRS ports and DMRS CDM groups to which the plurality of DMRS ports respectively belong, where DMRS ports belonging to a same DMRS port group are one DMRS port group.

In some embodiments, when the target rank is a relatively large rank in ranks indicated by the plurality of first indicator fields, the first Y ports in a plurality of DMRS ports indicated by the antenna port indicator field are DMRS ports corresponding to a target first indicator field, and the target first indicator field is a first indicator field that is in the plurality of first indicator fields and that indicates a relatively small rank.

In some embodiments, the target signaling includes one antenna port indicator field and at least two first indicator fields, the antenna port indicator field is used to indicate at least two DMRS port groups, and each DMRS port group includes at least one DMRS port.

In some embodiments, the antenna port indicator field uses one codepoint to indicate the at least two DMRS port groups.

In some embodiments, the antenna port indicator field indicates two DMRS port groups by using one codepoint, and the second DMRS port group is interpreted by a rank indicated by the second first indicator field.

In some embodiments, DMRS ports in different DMRS port groups correspond to different DMRS CDM groups.

In some embodiments, each DMRS port group corresponds to one first indicator field;
or
each DMRS port group corresponds to a rank indicator parameter indicated by one first indicator field; where
first indicator fields corresponding to different DMRS port groups are different.

In some embodiments, the target signaling further includes a first target indicator field, and the first target indicator field is used to indicate a first indicator field corresponding to the rank indicator parameter.

In some embodiments, ranks indicated by first indicator fields are the same.

In some embodiments, a target DMRS port group in the at least two DMRS port groups corresponds to a target first indicator field in the plurality of first indicator fields, and a rank indicated by the target first indicator field is equal to the number of DMRS ports in the target DMRS port group.

In some embodiments, ranks indicated by the plurality of first indicator fields are different.

In some embodiments, the determining module 72 is configured to determine the at least two DMRS port groups based on the antenna indicator field and a DMRS combination table, where the DMRS port combination table includes a first DMRS port combination table or a second DMRS port combination table, and the first DMRS port combination table includes a first DMRS port set.

In some embodiments, the determining the at least two DMRS port groups based on the antenna indicator field and the DMRS combination table includes:
if a first target indicator field does not exist in the target signaling, the terminal determines at least two DMRS port groups based on the first DMRS port combination table; and
if the first target indicator field exists in the target signaling, the terminal determines at least two DMRS port groups based on a second DMRS port combination table.

In some embodiments, the target signaling includes a plurality of antenna port indicator fields, and each antenna port indicator field is used to indicate one DMRS port.

In some embodiments, DMRS ports in the DMRS port group that are indicated by different antenna port indicator fields correspond to different DMRS CDM groups.

In some embodiments, the target signaling includes two antenna port indicator fields, the target signaling further includes two first indicator fields, and the second antenna port indicator field is associated with the second first indicator field.

In some embodiments, the target signaling further includes one or more first indicator fields, the target signaling includes two antenna port indicator fields, and the second antenna port indicator field is determined based on a target rank indicator parameter indicated by a target first indicator field.

In some embodiments, the target signaling further includes a first target indicator field, and the target rank indicator parameter is determined by using the first target indicator field.

In some embodiments, the target signaling includes one antenna port indicator field, the antenna port indicator field is used to indicate one DMRS port group, the first DMRS port group in the at least two DMRS port groups is the DMRS port group indicated by the antenna port indicator field, and remaining DMRS port groups are implicitly obtained based on the DMRS port group indicated by the antenna port indicator field.

In some embodiments, the remaining DMRS port groups are the same as the first DMRS port group.

In some embodiments, the remaining DMRS port groups are obtained in the following manner:
a DMRS CDM group corresponding to the first DMRS port group; and
a sequence of DMRS CDM groups corresponding to the first DMRS port group.

In some embodiments, the determining module 72 is configured to obtain an association relationship between a PTRS port and a DMRS port group, where the association relationship between a PTRS port and a DMRS port group is one of the following:
a plurality of PTRS ports are separately associated with the at least two DMRS port groups;
a plurality of PTRS ports are separately associated with a plurality of DMRS CDM groups;
a plurality of PTRS ports correspond to a target DMRS port group, and the target DMRS port group is a DMRS port group with the largest MCS in the at least two DMRS port groups; or
one PTRS port is associated with the at least two DMRS port groups.

In some embodiments, the target signaling further includes a PTRS-DMRS association field, and the PTRS-DMRS association field is used to indicate that a PTRS port is associated with a target DMRS port in an associated DMRS port group.

In some embodiments, a bit length of the PTRS-DMRS association field is X bits.

The PTRS-DMRS association field is used to indicate a target DMRS port associated with a target PTRS port in a target DMRS port group, the target DMRS port group is a DMRS port group with a larger number of DMRS ports, and the target PTRS port is a PTRS port associated with the target DMRS port group.

In some embodiments, the X bits of the PTRS-DMRS association field are divided into two parts respectively correspondingly indicating that two PTRS ports are associated with target DMRS ports in corresponding two groups of DMRS ports.

In some embodiments, that the PTRS-DMRS association field corresponds to the DMRS port group with a larger number of DMRS ports is valid when at least one of the following conditions is met:
numbers of the two groups of DMRS ports are not equal; or
ranks indicated by two first indicator fields are not equal.

In some embodiments, that the X bits of the PTRS-DMRS association field are divided into two parts respectively correspondingly indicating that two groups of DMRS port indicator fields is valid when at least one of the following conditions is met:
numbers of the two groups of DMRS ports are equal; or
ranks indicated by two first indicator fields are equal.

In some embodiments, the uplink transmission mode is a first transmission mode or a third transmission mode, the first transmission mode is to send a PUSCH by using one beam, and the third transmission mode is to send a PUSCH through TDM of a plurality of beams.

In some embodiments, the target signaling further includes a plurality of first indicator fields, and rank indicator parameters corresponding to one beam in the first transmission mode are indicated by the first first indicator field.

In some embodiments, the target signaling further includes a plurality of SRI indicator fields, one beam in the first transmission mode is the first beam, and the first beam is a spatial relationship or the first TCI state associated with an SRS resource indicated by the first SRI indicator field.

In some embodiments, one beam in the first transmission mode uses the first TCI state, and the first TCI state is indicated by other signaling.

In some embodiments, when the first transmission mode is used, the first Y DMRS ports in Z DMRS ports indicated by the antenna port indicator field are valid DMRS ports, and Y is a rank indicated by the first indicator field.

In some embodiments, the first transmission mode is used when at least one of the following conditions is met:
a rank of precoding indicated by the first indicator field is 1;
the first target indicator field indicates that one beam is used for transmission;
the antenna port indicator field indicates a reserved codepoint; or
DMRS ports indicated by the antenna indicator field belong to one CDM group.

In some embodiments, when the antenna port indicator field indicates a reserved codepoint, DMRS ports indicated by the antenna port indicator field are 0 to L−1, and Lis a rank indicated by the first indicator field.

In some embodiments, the first DMRS port group indicated by the antenna port indicator field takes effect when the first transmission mode is used.

In some embodiments, the third transmission mode is used when at least one of the following conditions is met:
the first target indicator field indicates that two beams are used for transmission; or
DMRS ports indicated by the antenna indicator field belong to one CDM group.

In some embodiments, the uplink transmission mode is a second transmission mode, and the second transmission mode is to simultaneously send a PUSCH by using a plurality of beams.

In some embodiments, the target signaling further includes one or more first indicator fields, and sending a PUSCH by using a plurality of beams includes:
sending the PUSCH by using two beams, where
M layers of the PUSCH are sent by using one beam, and N layers are sent by using another beam; where

$$M = ⌈ A / 2 ⌉ or M = ⌊ A / 2 ⌋ ;$$

$$N = A - M ;$$

and
A is a value of a total rank indicated by the first indicator field.

In some embodiments, the target signaling includes two first indicator fields; and
M and N are ranks indicated by the two first indicator fields respectively;
or
M and N are determined by two DMRS port groups.

In some embodiments, M and N are determined by two DMRS port groups, DMRS ports in the two DMRS port groups are separately from two DMRS CDM groups, Mis the number of DMRS ports in the first DMRS CDM group, and N is the number of DMRS ports in the second DMRS CDM group.

In some embodiments, the second transmission mode is used when the following condition is met: DMRS ports in the at least two DMRS port groups are from at least two DMRS CDM groups.

In some embodiments, the plurality of beams are mapped to the at least two DMRS port groups.

In some embodiments, the plurality of DMRS port groups include the first DMRS port group having a DMRS port with a smallest index.

In some embodiments, a mapping sequence of the beams and the DMRS port groups is indicated by a first target indicator field in the target signaling.

In some embodiments, the first DMRS port group corresponds to the first beam.

In some embodiments, the number of beams used by the terminal to send the PUSCH is indicated by a network side by using RRC configuration or DCI.

In some embodiments, the first target indicator field exists when at least one of the following conditions is met:
at least two SRS resource sets are configured;
a fourth transmission mode is configured, where the fourth transmission mode is a frequency division multiplexing manner or a transmission manner in which transmission of the PUSCH is associated with at least two target resources;
a fifth transmission mode is not configured, where the fifth transmission mode is a space division multiplexing manner;
at least one codepoint in a TCI indicator field is associated with two TCI states used for uplink transmission; or
there are two currently effective TCI states used for uplink transmission.

In some embodiments, a bit length of the first target indicator field is 1 bit when at least one of the following conditions is met:
at least two SRS resource sets are configured;
a fifth transmission mode is configured, where the fifth transmission mode is a space division multiplexing manner.

The reference signal port indication apparatus in this embodiment of this application may be an electronic device, for example, an electronic device with an operating system, or may be a component such as an integrated circuit or a chip in the electronic device. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

The reference signal port indication apparatus provided in this embodiment of this application can implement the processes implemented in the method embodiment shown in FIG. 5, and a same technical effect is achieved. To avoid repetition, details are not described herein again.

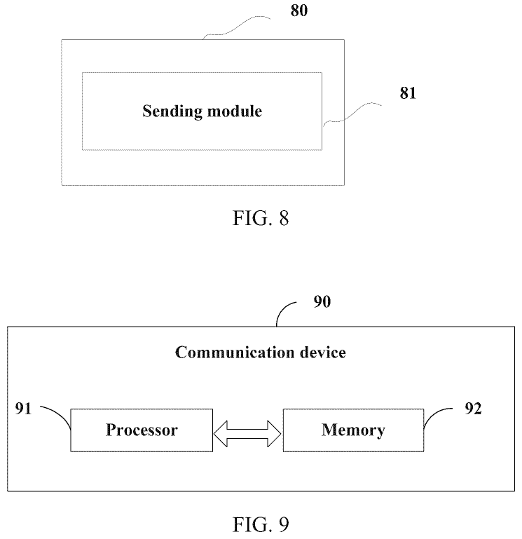

As shown in FIG. 8, an embodiment of this application further provides a reference signal port indication apparatus 80, including:
a sending module 81, configured to send target signaling, where the target signaling includes an antenna port indicator field, and the antenna port indicator field is used to indicate a DMRS port of an uplink channel, so that a terminal determines at least two DMRS port groups based on the antenna port indicator field, or determines an uplink transmission mode of the terminal based on the antenna port indicator field.

In some embodiments, the target signaling includes one antenna port indicator field, and the antenna port indicator field is used to indicate a plurality of DMRS ports;
or
the target signaling includes one antenna port indicator field, and the antenna port indicator field is used to indicate at least two DMRS ports;
or
the target signaling includes a plurality of antenna port indicator fields, and each antenna port indicator field is used to indicate one DMRS port;
or
the target signaling includes one antenna port indicator field, the antenna port indicator field is used to indicate one DMRS port group, the first DMRS port group in the at least two DMRS port groups is the DMRS port group indicated by the antenna port indicator field, and remaining DMRS port groups are implicitly obtained based on the DMRS port group indicated by the antenna port indicator field.

The reference signal port indication apparatus provided in this embodiment of this application can implement the processes implemented in the method embodiment shown in FIG. 6, and a same technical effect is achieved. To avoid repetition, details are not described herein again.

As shown in FIG. 9, an embodiment of this application further provides a communication device 90, including a processor 91 and a memory 92, and the memory 92 stores a program or an instruction that can run on the processor 91. For example, when the communication device 90 is a terminal, the program or the instruction is executed by the processor 91 to implement the steps of the foregoing embodiment of the reference signal port indication method performed by the terminal, and a same technical effect can be achieved. When the communication device 90 is a network side device, the program or the instruction is executed by the processor 91 to implement the steps of the foregoing embodiment of the reference signal port indication method performed by the network side device, and a same technical effect can be achieved. To avoid repetition, details are not described herein again.

An embodiment of this application further provides a terminal, including a processor and a communication interface. The communication interface is configured to receive target signaling, where the target signaling includes an antenna port indicator field, and the antenna port indicator field is used to indicate a DMRS port of an uplink channel. The processor is configured to determine at least two DMRS port groups based on the antenna port indicator field, or determine an uplink transmission mode of the terminal based on the antenna port indicator field.

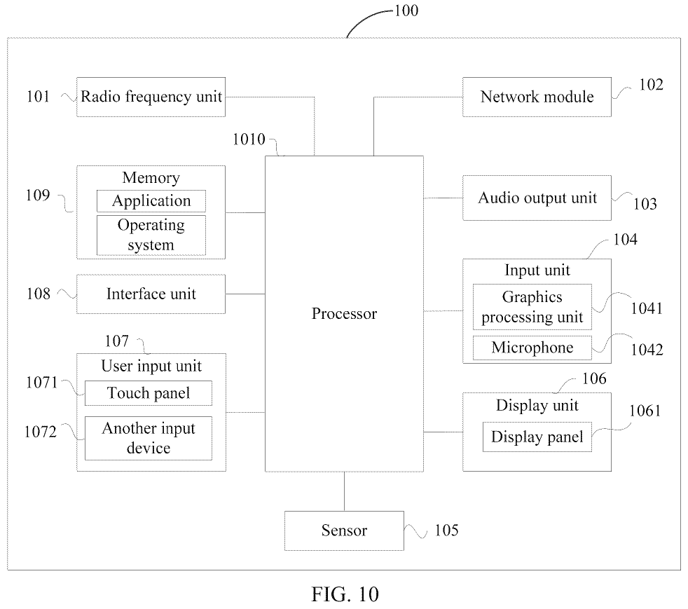

This terminal embodiment is corresponding to the terminal side method embodiment, each embodiment process and embodiment of the method embodiment can be applied to the terminal embodiment, and a same technical effect can be achieved. Specifically, FIG. 10 is a schematic diagram of a hardware structure of a terminal according to an embodiment of this application.

A terminal 100 includes but is not limited to at least a part of components such as a radio frequency unit 101, a network module 102, an audio output unit 103, an input unit 104, a sensor 105, a display unit 106, a user input unit 107, an interface unit 108, a memory 109, and a processor 1010.

A person skilled in the art can understand that the terminal 100 may further include a power supply (such as a battery) that supplies power to each component. The power supply may be logically connected to the processor 1010 by using a power supply management system, to implement functions such as charging and discharging management, and power consumption management by using the power supply management system. The terminal structure shown in FIG. 10 constitutes no limitation on the terminal, and the terminal may include more or fewer components than those shown in the figure, or combine some components, or have different component arrangements. Details are not described herein.

It should be understood that in this embodiment of this application, the input unit 104 may include a Graphics Processing Unit (GPU) 1041 and a microphone 1042. The graphics processing unit 1041 processes image data of a static picture or a video obtained by an image capture apparatus (for example, a camera) in a video capture mode or an image capture mode. The display unit 106 may include a display panel 1061, and the display panel 1061 may be configured in a form of a liquid crystal display, an organic light-emitting diode, or the like. The user input unit 107 includes at least one of a touch panel 1071 or another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 101 may transmit the downlink data to the processor 1010 for processing. In addition, the radio frequency unit 101 may send uplink data to the network side device. Generally, the radio frequency unit 101 includes but is not limited to an antenna, an amplifier, a transceiver, a coupler, a low noise amplifier, a duplexer, and the like.

The memory 109 may be configured to store a software program or an instruction and various data. The memory 109 may mainly include a first storage area for storing a program or an instruction and a second storage area for storing data. The first storage area may store an operating system, and an application or an instruction required by at least one function (for example, a sound playing function or an image playing function). In addition, the memory 109 may be a volatile memory or a non-volatile memory, or the memory 109 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 109 in this embodiment of this application includes but is not limited to these memories and any memory of another proper type.

The processor 1010 may include one or more processing units. In some embodiments, an application processor and a modem processor are integrated into the processor 1010. The application processor mainly processes an operating system, a user interface, an application, or the like. The modem processor mainly processes a wireless communication signal, for example, a baseband processor. It may be understood that, the modem processor may not be integrated into the processor 1010.

The radio frequency unit 101 is configured to receive target signaling, where the target signaling includes an antenna port indicator field, and the antenna port indicator field is used to indicate a DMRS port of an uplink channel.

The processor 1010 is configured to determine at least two DMRS port groups based on the antenna port indicator field, or determine an uplink transmission mode of a terminal based on the antenna port indicator field.

In this embodiment of this application, the terminal can determine at least two DMRS port groups, or determine an uplink transmission mode of the terminal based on the DMRS port used for the uplink channel and indicated by the antenna port indicator field. Because at least two DMRS port groups are determined, PUSCHs sent by using different beams in an MTRP scenario may correspondingly use DMRS ports in different DMRS port groups. When different time-frequency resources are used for DMRS ports in different DMRS port groups, mutual interference can be reduced, and transmission performance of uplink data is improved.

In some embodiments, the target signaling includes one antenna port indicator field and one or more first indicator fields, and the antenna port indicator field is used to indicate a plurality of DMRS ports.

The processor 1010 is configured to determine the at least two DMRS port groups based on a target rank and the antenna port indicator field, where the target rank is determined based on a rank indicated by the first indicator field.

In some embodiments, the target rank is a sum of ranks indicated by the plurality of first indicator fields;
or
the target rank is a relatively large rank in ranks indicated by the plurality of first indicator fields;
or
the target rank is a rank indicated by the first first indicator field in the plurality of first indicator fields.

In some embodiments, the first indicator field is a valid indicator field.

In some embodiments, the sum of the ranks indicated by the plurality of first indicator fields does not exceed a maximum rank limit.

In some embodiments, the processor 1010 is configured to group, based on the target rank, a plurality of DMRS ports indicated by the antenna port indicator field into the at least two DMRS port groups.

In some embodiments, the grouping, based on the target rank, a plurality of DMRS ports indicated by the antenna port indicator field into the at least two DMRS port groups includes:
grouping the plurality of DMRS ports into the at least two DMRS port groups based on an index value of a DMRS port, where a port index of a DMRS port in a DMRS port group is less than a port index of a DMRS port in a subsequent DMRS port group;
or
grouping the plurality of DMRS ports into the at least two DMRS port groups based on arrangement locations of the plurality of DMRS ports;
or
grouping the plurality of DMRS ports into the at least two DMRS port groups based on the plurality of DMRS ports and DMRS CDM groups to which the plurality of DMRS ports respectively belong, where DMRS ports belonging to a same DMRS port group are one DMRS port group.

In some embodiments, when the target rank is a relatively large rank in ranks indicated by the plurality of first indicator fields, the first Y ports in a plurality of DMRS ports indicated by the antenna port indicator field are DMRS ports corresponding to a target first indicator field, and the target first indicator field is a first indicator field that is in the plurality of first indicator fields and that indicates a relatively small rank.

In some embodiments, the target signaling includes one antenna port indicator field and at least two first indicator fields, the antenna port indicator field is used to indicate at least two DMRS port groups, and each DMRS port group includes at least one DMRS port.

In some embodiments, the antenna port indicator field uses one codepoint to indicate the at least two DMRS port groups.

In some embodiments, the antenna port indicator field indicates two DMRS port groups by using one codepoint, and the second DMRS port group is interpreted by a rank indicated by the second first indicator field.

In some embodiments, DMRS ports in different DMRS port groups correspond to different DMRS CDM groups.

In some embodiments, each DMRS port group corresponds to one first indicator field;
or
each DMRS port group corresponds to a rank indicator parameter indicated by one first indicator field; where
first indicator fields corresponding to different DMRS port groups are different.

In some embodiments, the target signaling further includes a first target indicator field, and the first target indicator field is used to indicate a first indicator field corresponding to the rank indicator parameter.

In some embodiments, ranks indicated by first indicator fields are the same.

In some embodiments, a target DMRS port group in the at least two DMRS port groups corresponds to a target first indicator field in the plurality of first indicator fields, and a rank indicated by the target first indicator field is equal to the number of DMRS ports in the target DMRS port group.

In some embodiments, ranks indicated by the plurality of first indicator fields are different.

In some embodiments, the processor 1010 is configured to determine the at least two DMRS port groups based on the antenna indicator field and a DMRS combination table, where the DMRS port combination table includes a first DMRS port combination table or a second DMRS port combination table, and the first DMRS port combination table includes a first DMRS port set.

In some embodiments, the determining the at least two DMRS port groups based on the antenna indicator field and the DMRS combination table includes:
if a first target indicator field does not exist in the target signaling, the terminal determines at least two DMRS port groups based on the first DMRS port combination table; and
if the first target indicator field exists in the target signaling, the terminal determines at least two DMRS port groups based on a second DMRS port combination table.

In some embodiments, the target signaling includes a plurality of antenna port indicator fields, and each antenna port indicator field is used to indicate one DMRS port.

In some embodiments, DMRS ports in the DMRS port group that are indicated by different antenna port indicator fields correspond to different DMRS CDM groups.

In some embodiments, the target signaling includes two antenna port indicator fields, the target signaling further includes two first indicator fields, and the second antenna port indicator field is associated with the second first indicator field.

In some embodiments, the target signaling further includes one or more first indicator fields, the target signaling includes two antenna port indicator fields, and the second antenna port indicator field is determined based on a target rank indicator parameter indicated by a target first indicator field.

In some embodiments, the target signaling further includes a first target indicator field, and the target rank indicator parameter is determined by using the first target indicator field.

In some embodiments, the target signaling includes one antenna port indicator field, the antenna port indicator field is used to indicate one DMRS port group, the first DMRS port group in the at least two DMRS port groups is the DMRS port group indicated by the antenna port indicator field, and remaining DMRS port groups are implicitly obtained based on the DMRS port group indicated by the antenna port indicator field.

In some embodiments, the remaining DMRS port groups are the same as the first DMRS port group.

In some embodiments, the remaining DMRS port groups are obtained in the following manner:
a DMRS CDM group corresponding to the first DMRS port group; and
a sequence of DMRS CDM groups corresponding to the first DMRS port group.

In some embodiments, the processor 1010 is configured to obtain an association relationship between a PTRS port and a DMRS port group, where the association relationship between a PTRS port and a DMRS port group is one of the following:
a plurality of PTRS ports are separately associated with the at least two DMRS port groups;
a plurality of PTRS ports are separately associated with a plurality of DMRS CDM groups;
a plurality of PTRS ports correspond to a target DMRS port group, and the target DMRS port group is a DMRS port group with the largest MCS in the at least two DMRS port groups; or
one PTRS port is associated with the at least two DMRS port groups.

In some embodiments, the target signaling further includes a PTRS-DMRS association field, and the PTRS-DMRS association field is used to indicate that a PTRS port is associated with a target DMRS port in an associated DMRS port group.

In some embodiments, a bit length of the PTRS-DMRS association field is X bits.

The PTRS-DMRS association field is used to indicate the target DMRS port is associated with a target PTRS port in a target DMRS port group, the target DMRS port group is a DMRS port group with a larger number of DMRS ports, and the target PTRS port is a PTRS port associated with the target DMRS port group.

In some embodiments, the X bits of the PTRS-DMRS association field are divided into two parts respectively correspondingly indicating that two PTRS ports are associated with target DMRS ports in corresponding two groups of DMRS ports.

In some embodiments, that the PTRS-DMRS association field corresponds to the DMRS port group with a larger number of DMRS ports is valid when at least one of the following conditions is met:
numbers of the two groups of DMRS ports are not equal; or
ranks indicated by two first indicator fields are not equal.

In some embodiments, that the X bits of the PTRS-DMRS association field are divided into two parts respectively correspondingly indicating that two groups of DMRS port indicator fields is valid when at least one of the following conditions is met:
numbers of the two groups of DMRS ports are equal; or
ranks indicated by two first indicator fields are equal.

In some embodiments, the uplink transmission mode is a first transmission mode or a third transmission mode, the first transmission mode is to send a PUSCH by using one beam, and the third transmission mode is to send a PUSCH through TDM of a plurality of beams.

In some embodiments, the target signaling further includes a plurality of first indicator fields, and rank indicator parameters corresponding to one beam in the first transmission mode are indicated by the first first indicator field.

In some embodiments, the target signaling further includes a plurality of SRI indicator fields, one beam in the first transmission mode is the first beam, and the first beam is a spatial relationship or the first TCI state associated with an SRS resource indicated by the first SRI indicator field.

In some embodiments, one beam in the first transmission mode uses the first TCI state, and the first TCI state is indicated by other signaling.

In some embodiments, when the first transmission mode is used, the first Y DMRS ports in Z DMRS ports indicated by the antenna port indicator field are valid DMRS ports, and Y is a rank indicated by the first indicator field.

In some embodiments, the first transmission mode is used when at least one of the following conditions is met:
a rank of precoding indicated by the first indicator field is 1;
the first target indicator field indicates that one beam is used for transmission;
the antenna port indicator field indicates a reserved codepoint; or
DMRS ports indicated by the antenna indicator field belong to one CDM group.

In some embodiments, when the antenna port indicator field indicates a reserved codepoint, DMRS ports indicated by the antenna port indicator field are 0 to L−1, and Lis a rank indicated by the first indicator field.

In some embodiments, the first DMRS port group indicated by the antenna port indicator field takes effect when the first transmission mode is used.

In some embodiments, the third transmission mode is used when at least one of the following conditions is met:
the first target indicator field indicates that two beams are used for transmission; or
DMRS ports indicated by the antenna indicator field belong to one CDM group.

In some embodiments, the uplink transmission mode is a second transmission mode, and the second transmission mode is to simultaneously send a PUSCH by using a plurality of beams.

In some embodiments, the target signaling further includes one or more first indicator fields, and sending a PUSCH by using a plurality of beams includes:
sending the PUSCH by using two beams, where
M layers of the PUSCH are sent by using one beam, and N layers are sent by using another beam; where

$$M = ⌈ A / 2 ⌉ or M = ⌊ A / 2 ⌋ ;$$

$$N = A - M ;$$

and
A is a value of a total rank indicated by the first indicator field.

In some embodiments, the target signaling includes two first indicator fields; and
M and N are ranks indicated by the two first indicator fields respectively;
or
M and N are determined by two DMRS port groups.

In some embodiments, M and N are determined by two DMRS port groups, DMRS ports in the two DMRS port groups are separately from two DMRS CDM groups, M is the number of DMRS ports in the first DMRS CDM group, and N is the number of DMRS ports in the second DMRS CDM group.

In some embodiments, the second transmission mode is used when the following condition is met: DMRS ports in the at least two DMRS port groups are from at least two DMRS CDM groups.

In some embodiments, the plurality of beams are mapped to the at least two DMRS port groups.

In some embodiments, the plurality of DMRS port groups include the first DMRS port group having a DMRS port with a smallest index.

In some embodiments, a mapping sequence of the beams and the DMRS port groups is indicated by a first target indicator field in the target signaling.

In some embodiments, the first DMRS port group corresponds to the first beam.

In some embodiments, the number of beams used by the terminal to send the PUSCH is indicated by a network side by using RRC configuration or DCI.

In some embodiments, the first target indicator field exists when at least one of the following conditions is met:
at least two SRS resource sets are configured;
a fourth transmission mode is configured, where the fourth transmission mode is a frequency division multiplexing manner or a transmission manner in which transmission of the PUSCH is associated with at least two target resources;
a fifth transmission mode is not configured, where the fifth transmission mode is a space division multiplexing manner;
at least one codepoint in a TCI indicator field is associated with two TCI states used for uplink transmission; or
there are two currently effective TCI states used for uplink transmission.

In some embodiments, a bit length of the first target indicator field is 1 bit when at least one of the following conditions is met:
at least two SRS resource sets are configured;
a fifth transmission mode is configured, where the fifth transmission mode is a space division multiplexing manner.

An embodiment of this application further provides a network side device, including a processor and a communications interface. The communication interface is configured to send target signaling, where the target signaling includes an antenna port indicator field, and the antenna port indicator field is used to indicate an DMRS port of an uplink channel, so that a terminal determines at least two DMRS port groups based on the antenna port indicator field, or determines an uplink transmission mode of the terminal based on the antenna port indicator field. This network side device embodiment is corresponding to the foregoing method embodiment of the network side device. Each embodiment process and embodiment of the foregoing method embodiment may be applicable to this network side device embodiment, and a same technical effect can be achieved.

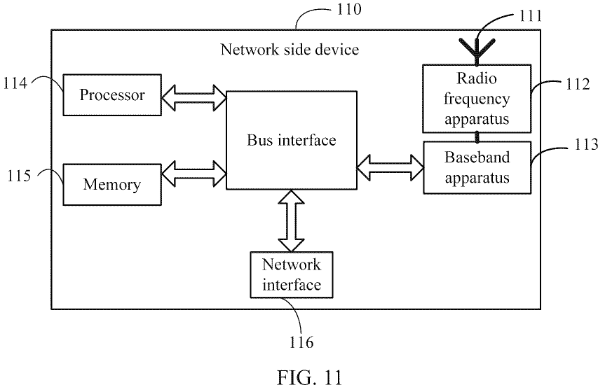

Specifically, an embodiment of this application further provides a network side device. As shown in FIG. 11, a network side device 110 includes an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information by using the antenna 111, and sends the received information to the baseband apparatus 113 for processing. In a downlink direction, the baseband apparatus 113 processes information that needs to be sent, and sends processed information to the radio frequency apparatus 112. The radio frequency apparatus 112 processes the received information, and sends processed information by using the antenna 111.

In the foregoing embodiment, the method performed by the network side device may be implemented in a baseband apparatus 113. The baseband apparatus 113 includes a baseband processor.

For example, the baseband apparatus 113 may include at least one baseband board. A plurality of chips are disposed on the baseband board. As shown in FIG. 11, one chip is, for example, a baseband processor, and is connected to the memory 115 by using a bus interface, to invoke a program in the memory 115 to perform the operations of the network device shown in the foregoing method embodiment.

The network side device may further include a network interface 116, and the interface is, for example, a common public radio interface (CPRI).

Specifically, the network side device 110 in this embodiment of this application further includes an instruction or a program that is stored in the memory 115 and that can run on the processor 114. The processor 114 invokes the instruction or the program in the memory 115 to perform the method performed by the modules shown in FIG. 8, and a same technical effect is achieved. To avoid repetition, details are not described herein again.

An embodiment of this application further provides a readable storage medium. The readable storage medium stores a program or an instruction, and when the program or the instruction is executed by a processor, the processes in the embodiment of the reference signal port indication method are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing embodiment of the reference signal port indication method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the foregoing embodiment of the reference signal port indication method, and a same technical effect can be achieved. To avoid repetition, details are not described herein again.

An embodiment of this application further provides a reference signal port indication system, including a terminal and a network side device. The terminal may be configured to perform the steps of the reference signal port indication method performed by the terminal, and the network side device may be configured to perform the steps of the reference signal port indication method performed by the network side device.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing embodiments, a person skilled in the art may clearly understand that the method in the foregoing embodiment may be implemented by software in addition to a necessary universal hardware platform or by hardware only. In most circumstances, the former is a preferred embodiment. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific embodiments, and the foregoing specific embodiments are only illustrative and not restrictive. Under the enlightenment of this application, a person of ordinary skill in the art can make many forms without departing from the purpose of this application and the protection scope of the claims, all of which fall within the protection of this application.

1. A method for reference signal port indication, comprising:
receiving, by a terminal, target signaling, wherein the target signaling comprises an antenna port indicator field, and the antenna port indicator field is used to indicate a demodulation reference signal (DMRS) port of an uplink channel; and
determining, by the terminal, at least two DMRS port groups based on the antenna port indicator field.

2. The method according to claim 1, wherein the target signaling comprises one antenna port indicator field and one or more first indicator fields, and the antenna port indicator field is used to indicate a plurality of DMRS ports; and
the determining, by the terminal, at least two DMRS port groups based on the antenna port indicator field comprises:
determining, by the terminal, the at least two DMRS port groups based on a target rank and the antenna port indicator field,
wherein the target rank is determined based on a rank indicated by the first indicator field.

3. The method according to claim 2, wherein
the target rank is a sum of ranks indicated by a plurality of first indicator fields.

4. The method according to claim 2, wherein the determining, by the terminal, at least two DMRS port groups based on a target rank and the antenna port indicator field comprises:
grouping, by the terminal based on the target rank, the plurality of DMRS ports indicated by the antenna port indicator field into the at least two DMRS port groups.

5. The method according to claim 4, wherein the grouping, by the terminal based on the target rank, the plurality of DMRS ports indicated by the antenna port indicator field into the at least two DMRS port groups comprises:
grouping, by the terminal, the plurality of DMRS ports into the at least two DMRS port groups based on an index value of a DMRS port, wherein a port index of a DMRS port in a DMRS port group is less than a port index of a DMRS port in a subsequent DMRS port group;
or
grouping, by the terminal, the plurality of DMRS ports into the at least two DMRS port groups based on arrangement locations of the plurality of DMRS ports;
or
grouping, by the terminal, the plurality of DMRS ports into the at least two DMRS port groups based on the plurality of DMRS ports and DMRS Code Domain Multiplexing (CDM) groups to which the plurality of DMRS ports respectively belong, wherein DMRS ports belonging to a same DMRS port group are one DMRS port group.

6. The method according to claim 2, wherein:
each DMRS port group corresponds to one first indicator field;
or
each DMRS port group corresponds to a rank indicator parameter indicated by one first indicator field,
wherein first indicator fields corresponding to different DMRS port groups are different.

7. The method according to claim 1, wherein the determining, by the terminal, at least two DMRS port groups based on the antenna port indicator field comprises:
determining, by the terminal, the at least two DMRS port groups based on the antenna indicator field and a DMRS ports combination table, wherein the DMRS port combination table comprises a first DMRS port combination table or a second DMRS port combination table, and the first DMRS port combination table comprises a first DMRS port set.

8. The method according to claim 7, wherein the determining, by the terminal, the at least two DMRS port groups based on the antenna indicator field and a DMRS combination table comprises:
when a first target indicator field does not exist in the target signaling, determining, by the terminal, the at least two DMRS port groups based on the first DMRS port combination table; and
when the first target indicator field exists in the target signaling, determining, by the terminal, the at least two DMRS port groups based on the second DMRS port combination table.

9. The method according to claim 1, wherein the target signaling comprises a plurality of antenna port indicator fields, and each antenna port indicator field is used to indicate one DMRS port group.

10. The method according to claim 9, wherein the target signaling comprises two antenna port indicator fields, the target signaling further comprises two first indicator fields, and the second antenna port indicator field is associated with the second first indicator field.

11. The method according to claim 10, wherein the target signaling further comprises one or more first indicator fields, the target signaling comprises two antenna port indicator fields, and the second antenna port indicator field is determined based on a target rank indicator parameter indicated by a target first indicator field.

12. The method according to claim 1, wherein the determining, by the terminal, at least two DMRS port groups based on the antenna port indicator field further comprises:
obtaining, by the terminal, an association relationship between a phase-tracking reference signal (PTRS) port and a DMRS port group, wherein the association relationship between a PTRS port and a DMRS port group is one of the following:
a plurality of PTRS ports are separately associated with the at least two DMRS port groups;
a plurality of PTRS ports are separately associated with a plurality of DMRS CDM groups;
a plurality of PTRS ports correspond to a target DMRS port group, and the target DMRS port group is a DMRS port group with the largest MCS in the at least two DMRS port groups; or
one PTRS port is associated with the at least two DMRS port groups.

13. The method according to claim 12, wherein the target signaling further comprises a PTRS-DMRS association field, and the PTRS-DMRS association field is used to indicate that a PTRS port is associated with a target DMRS port in an associated DMRS port group.

14. The method according to claim 1, wherein:
the terminal determines the uplink transmission mode of the terminal based on the antenna port indicator field, wherein the uplink transmission mode is a first transmission mode, a second transmission mode, or a third transmission mode, the first transmission mode is to send a Physical Uplink Shared Channel (PUSCH) by using one beam, the second transmission mode is to send a PUSCH by using a plurality of beams, and the third transmission mode is to send a PUSCH through Time-Division Multiplexing (TDM) of a plurality of beams.

15. The method according to claim 14, wherein the first transmission mode is used when at least one of the following conditions is met:
a rank of precoding indicated by the first indicator field is 1;
the first target indicator field indicates that one beam is used for transmission;
the antenna port indicator field indicates a reserved codepoint; or
DMRS ports indicated by the antenna indicator field belong to one CDM group.

16. The method according to claim 14, wherein the third transmission mode is used when at least one of the following conditions is met:
the first target indicator field indicates that two beams are used for transmission; or
DMRS ports indicated by the antenna indicator field belong to one CDM group.

17. The method according to claim 13, wherein the second transmission mode is used when the following condition is met: DMRS ports in the at least two DMRS port groups are from at least two DMRS CDM groups.

18. A method for reference signal port indication, comprising:
sending, by a network side device, target signaling, wherein the target signaling comprises an antenna port indicator field and one or more first indicator fields,
wherein the antenna port indicator field is used to indicate a DMRS port of an uplink channel;
the one or more first indicator fields are used to determine a target rank; and
the antenna port indicator field and the target rank are used to determine at least two DMRS port groups.

19. A terminal, comprising: a memory storing a computer program; and a processor coupled to the memory and configured to execute the computer program to perform operations comprising:
receiving target signaling, wherein the target signaling comprises an antenna port indicator field, and the antenna port indicator field is used to indicate a demodulation reference signal (DMRS) port of an uplink channel; and
determining at least two DMRS port groups based on the antenna port indicator field.

20. A network side device, comprising: a memory storing a computer program; and a processor coupled to the memory and configured to execute the computer program to perform the method according to claim 18.
